(19) United States
(12) Patent Application Publication
(10) Pub. No.: US 2019/0086727 A1
(43) Pub. Date: Mar. 21, 2019

(54) DISPLAY BACKLIGHT OPTIMIZATION

(71) Applicant: INTEL CORPORATION, Santa Clara, CA (US)

(72) Inventors: Vijayakumar A. Dibbad, Bangalore (IN); Mallari C. Hanchate, Bangalore (IN)

(73) Assignee: INTEL CORPORATION, Santa Clara, CA (US)

(21) Appl. No.: 15/711,014

(22) Filed: Sep. 21, 2017

(51) Int. Cl. G02F 1/1335; G09G 3/34; G09G 3/3258

(52) U.S. Cl. CPC G02F 1/133603; H05B 33/0803; G09G 3/3258; G09G 3/342

(57) ABSTRACT

In some examples, display backlight strings are grouped into at least two groups based on characteristics of the display backlight strings. A first of the at least two groups of display backlight strings is operated at a first operating voltage. A second of the at least two groups of display backlight strings is operated at a second operating voltage.

### TECHNICAL FIELD

This disclosure relates generally to display backlights.

### BACKGROUND

Light emitting diodes (LEDs) used in display backlights are typically the highest power consuming devices included in a display panel. The forward voltage (V_{f}) and forward current (I_{f}) of LEDs can vary from part to part due to different factors such as, for example, semiconductor material, semiconductor process, operating temperature, etc. This can result in a variation in brightness of the LEDs used in the display backlight.

### BRIEF DESCRIPTION OF THE DRAWINGS

The following detailed description may be better understood by referencing the accompanying drawings, which contain specific examples of numerous features of the disclosed subject matter.

FIG. 1 illustrates forward voltage and forward current characteristics of light sources;

FIG. 2A illustrates voltages of display backlight strings;

FIG. 2B illustrates display backlight string groupings;

FIG. 3 illustrates display backlight voltage optimization;

FIG. 4 illustrates display backlight control;

FIG. 5 illustrates a computing device;

FIG. 6 illustrates one or more processor and one or more tangible, non-transitory computer readable media;

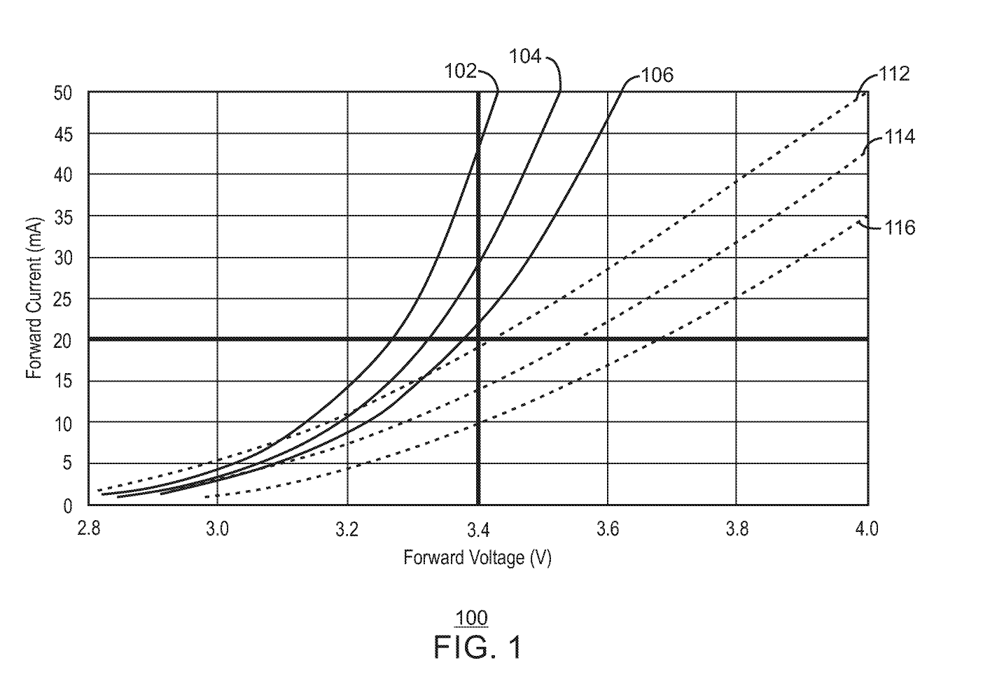

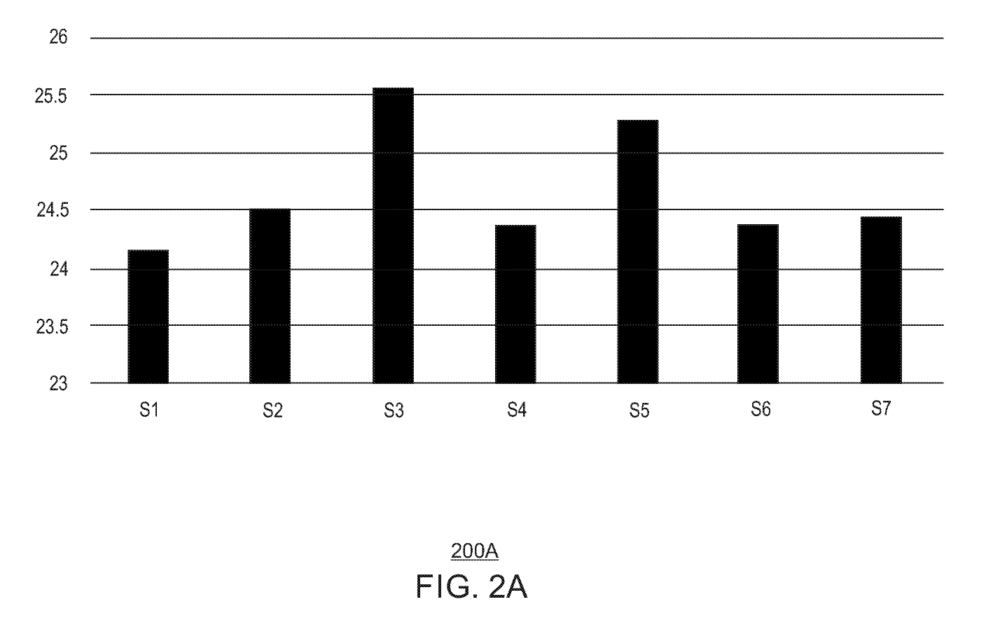

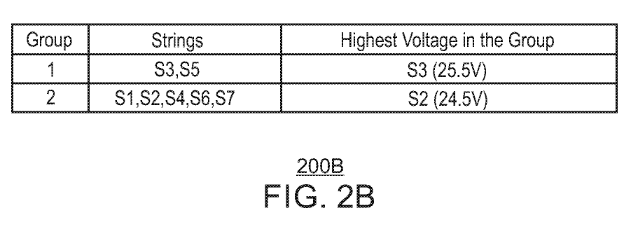

In some cases, the same numbers are used throughout the disclosure and the figures to reference like components and features. In some cases, numbers in the 100 series refer to features originally found in FIG. 1; numbers in the 200 series refer to features originally found in FIG. 2; and so on.

### DESCRIPTION OF SOME EMBODIMENTS

Some embodiments relate to display backlights. Some embodiments relate to display backlight control. Some embodiments relate to display backlight optimization. Some embodiments relate to display backlight voltage optimization. Some embodiments relate to display backlight power optimization. Some embodiments relate to reducing display power level. Some embodiments relate to optimizing display backlight operating voltage. Some embodiments relate to characterizing (for example, auto characterizing) display backlight strings (for example, display backlight light emitting diode strings). Some embodiments relate to characterizing (for example, auto characterizing) display backlight strings (for example, display backlight light emitting diode strings) on individual display panels. Some embodiments relate to display power saving by optimizing backlight voltage (for example, by characterizing voltage curves of display backlight strings such as LED strings on individual display panels). Some embodiments relate to one or more display backlight light source drivers (for example, one or more display backlight light emitting diode drivers).

Light sources used in display backlights, such as, for example, light emitting diodes (LEDs), are typically the highest power consuming devices included in a display panel. The forward voltage (V_{f}) and forward current (I_{f}) of light sources such as LEDs can vary from part to part due to different factors. For example, forward voltage vs. forward current characteristics can vary from part to part and/or from manufacturer to manufacturer based on one or more factors such as semiconductor material, semiconductor process, operating temperature, etc., among others. This can result in a variation in brightness of the light sources (for example, of LEDs) used in the display backlight.

In order to address these types of issues, display backlight drivers could use adaptive output voltage control in which backlight output voltage is set based on an LED string with a maximum voltage drop for a given constant forward current. However, in such an implementation other strings in the display backlight array may operate at a higher voltage, which could result in power loss.

FIG. 1 illustrates an exemplary graph 100 with forward current (Iᵣ) in milliamps on the vertical axis and forward voltage (V_{f}) in volts on the horizontal axis. Graph 100 of FIG. 1 includes forward current vs. forward voltage example curves 102, 104, 106, 112, 114 and 116. Exemplary solid curves 102, 104 and 106 represent forward current vs. forward voltage for a random set of LEDs of a first brand. Exemplary dotted curves 112, 114 and 116 represent forward current vs. forward voltage for a random set of LEDs of a second brand. As illustrated in graph 100, forward voltage and forward current specifications of LEDs can have considerable variations between LEDs of the same brand and/or between LEDs of different brands. A dark line at the forward current value of 20 mA is also illustrated in FIG. 1. This dark line represents a forward current of 20 mA as an example string current for a string of LEDs in a display backlight array. As illustrated in example graph 100, various LEDs can have forward voltage (V_{f}) variations ranging from 150 mV to 250 mV, for example. For example, at a forward current (Vᵢ) value of 20 mA, graph 100 illustrates a forward voltage (V_{f}) variation between forward current vs. forward voltage example curves 112, 114 and 116 of brand B LEDs ranging approximately 250 mV from part to part.

Backlight display drivers could use an adaptive output voltage control system in which backlight output voltage is set based on an LED string with a maximum voltage drop for a given constant forward current. However, other strings in the display backlight array could then be operating at a higher voltage. This can result in power loss.

Reducing output voltage of a backlight display can reduce backlight power, but such a reduction may result in uneven display backlight string brightness (for example, an uneven display backlight LED string brightness), since some strings may need a higher forward voltage in order to conduct a required current. Backlight display drivers could use adaptive output voltage control or constant current control. However, those types of approaches may result in added power losses on strings with better characteristics (for example, better forward voltage vs. forward current characteristics), since voltage on those strings would typically be higher than what is required to maintain a constant current.

In some embodiments, each string (for example, each string of LEDs) in a backlight display array can be auto-characterized. This can result in a display backlight with one or more group of strings (for example, LED strings) with better characteristics being operated at an optimized voltage level, and with one or more group of strings with lesser characteristics (for example, one or more group of strings with a higher voltage drop) being operated at a different voltage. According to some embodiments, this can result in a power loss reduction on display backlight strings with better characteristics (for example, with better forward voltage vs. forward current characteristics) and/or with a uniform brightness in all strings. In some embodiments, for example, backlight driver control can determine an optimal backlight operating voltage (for example, an optimal backlight operating voltage for individual display panels), and/or can set a unique backlight voltage (for example, a unique backlight voltage for each display panel).

In some embodiments, output voltage of a display backlight driver such as a boost backlight driver can be reduced to provide a considerable power reduction. At the same time, a uniform brightness of the display backlight strings can be maintained. In some embodiments, this can be accomplished using a negative voltage technique. According to some embodiments, display backlight light source strings (for example, display backlight LED strings) with closely comparable characteristics can be grouped together, and a backlight boost output (and/or backlight voltage output) is set at an optimized voltage level. This can reduce power loss in the backlight display strings. In some embodiments, negative voltage biasing can be implemented to maintain a voltage potential on display backlight strings needing higher voltage for constant current. This can help to maintain a uniform brightness of each of the display backlight strings. According to some embodiments, this can be implemented using a charge pump and transistor control logic integration (for example, field effect transistor control logic integration). In some embodiments, backlight power can be maximized while maintaining a low cost.

FIG. 2A illustrates a chart 200A with example voltages of display backlight strings (for example, voltages of display backlight LED strings). Chart 200A shows example voltages on the vertical axis (in volts) for each of seven backlight strings on the horizontal axis, including strings S1, S2, S3, S4, S5, S6, and S7. While chart 200A uses seven exemplary backlight strings, it is noted that any number of backlight strings may be included in some embodiments. The voltages shown in FIG. 2A show representative example voltages for each of the strings to maintain a constant current. For example, in some embodiments, the voltages shown in FIG. 2A might show representative example voltages for each of the strings to maintain a constant current of 20 mA.

In one example, a display backlight array has seven strings S1, S2, S3, S4, S5, S6 and S7, with, for example, seven LEDs in each string. In some embodiments, a constant current in each string is 20 mA (milliamps), and a total current in all strings (calculated by multiplying 20 mA in one string times the number of strings) is 140 mA.

In some embodiments, if adaptive output control is used with a string requiring a higher forward voltage (for example, if a string has a higher number of LEDs in series), a constant current sink circuit and/or voltage detection logic can set a backlight input voltage to maintain a constant current on that string. According to some embodiments, display backlight strings can be grouped based on proximity data.

In the example chart 200A of FIG. 2A, string S3 requires the highest voltage of each of the strings, which is approximately 25.5V (volts). This can be a sum of forward voltages of LEDs in string S3 that is required to maintain a constant current in that string, for example, and an output of the backlight LED driver will be 25.5V. In a full bright mode, output power of the display backlight (for example, of the display backlight boost voltage controller) would be approximately 3.57 W (Watts), which is determined by multiplying the voltage of 25.5V by 140 mA.

In some embodiments, strings with closely matching characteristics are grouped together, and backlight output voltage (backlight boost output voltage) is set. The voltage distribution on each string in FIG. 2A is example data of a typical pattern in view of large forward voltage tolerances of LEDs in display backlight strings.

FIG. 2B illustrates an example chart 200B that groups strings S1, S2, S3, S4, S5, S6 and S7 of FIG. 2A based on a number of the strings and based on proximity data. It is noted that the grouping of chart 200B is an example, and that other groupings are possible according to some embodiments.

In FIG. 2B, strings S3 and S5 are grouped together in a first group, and strings S1, S2, S4, S6 and S7 are grouped together in a second group. This grouping can be done, for example, using the voltages illustrated in FIG. 2A for each of the strings, with strings having similar high or low voltages being grouped together, for example. In some embodiments, the highest voltage of each group is used (for example, FIG. 2B illustrates use of string S3 voltage 25.5V for group 1, and use of string S2 voltage 24.5V for group 2). Although FIG. 2B illustrates grouping based on voltages illustrated in FIG. 2A, and use of the highest voltage in each group, it is noted that other embodiments can be implemented in which other characteristics are used.

In some embodiments, once the groupings are finalized, an output voltage is set. For example, in some embodiments, display backlight command voltages are set based on one or more of the highest group voltages. For example, in some embodiments, the group 2 voltage of 24.5V can be used as an output voltage. In some embodiments, a negative voltage amplitude can be calculated to maintain a 25.5V voltage potential on strings S3 and S5. A negative charge pump can be integrated, for example, in a display backlight controller (for example, a voltage controller and/or a boost controller). In the example illustrated in FIG. 2A and FIG. 2B, a negative charge pump such as an integrated negative charge pump can be controlled to set its amplitude at −1V (24.5V−25.5V=−1V). With this configuration, in some embodiments, output power (for example, boost driver output power) is 3.43 W (24.5V×140 mA), and power on the negative charge pump would be 40 mW (negative voltage×2 strings current).

In some embodiments, power can be saved. For example, in some embodiments, a negative voltage source integrated in a display backlight is implemented using an inverted charge pump. It is noted that a small power loss may occur due to the negative charge pump in some embodiments. When adding boost and charge pump power, in some embodiments, total power savings can be much larger than the loss due to the negative charge pump. In any case, backlight array power savings may vary from panel to panel.

In some embodiments, backlight operating voltage can be optimized. For example, in some embodiments, each display backlight string is characterized for forward voltage and current. This characterization can be implemented, for example, during a display turn-on event. A backlight driver controller can calibrate each display backlight string (for example, each display backlight LED string) on a backlight array. The calibration of each string can be implemented for a defined constant current by adaptively increasing the backlight voltage, for example. Once all strings are calibrated, a controller (for example, the backlight controller, a backlight driver, a processor, a system on chip or SoC, etc.) can decide on a grouping of the strings to operate the strings at optimized voltages. It is noted that the grouping of the strings can be implemented on a controller internal to the display and/or the display backlight, can be implemented outside a controller internal to the display/or the display backlight, or a combination of both.

In some embodiments, a set of strings with a higher voltage drop can be grouped separately and a negative voltage can be applied to the other end of the grouped strings (for example, using an integrated negative charge pump in the backlight driver). In some embodiments, the grouping and/or the application of a negative voltage drop can be implemented based on one or more strings with a maximum voltage drop, but in other embodiments it can be implemented in other ways. In embodiments, in which a negative voltage is applied, a negative voltage drop is applied to an end of the grouped strings so that a required minimum voltage potential is maintained on the strings (for example, to maintain a uniform brightness of the strings). In some embodiments, backlight operating voltage can be reduced, and operating strings with higher voltage drops can be maintained at a desired voltage potential by applying a voltage such as a negative voltage. In some embodiments, any power loss associated with a negative charge pump will be relatively small.

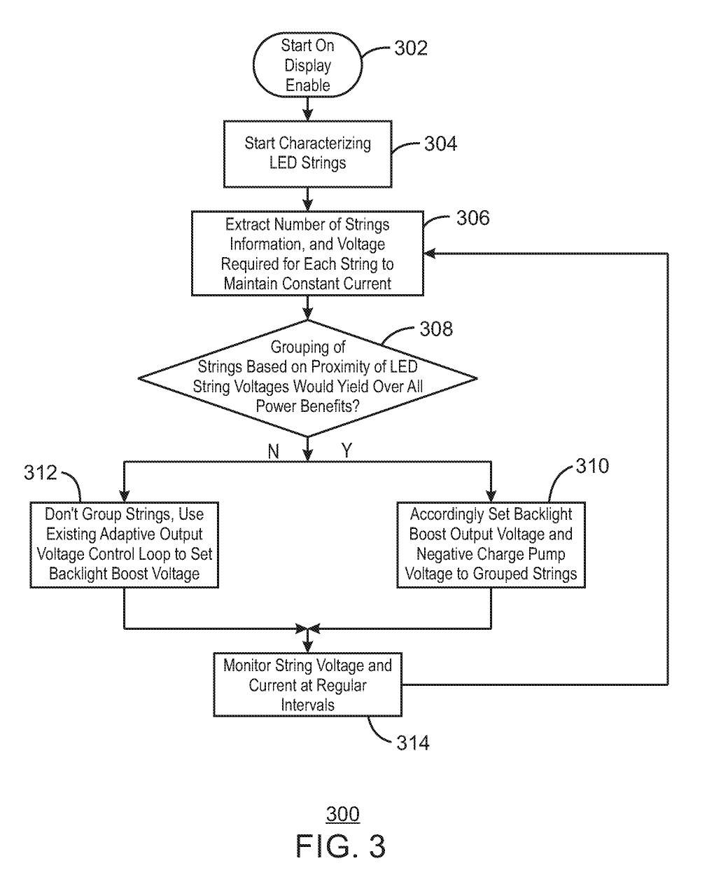

FIG. 3 illustrates display backlight voltage optimization 300 according to some embodiments. In some embodiments, display backlight voltage optimization 300 includes characterization and grouping of display backlight strings (for example, of display backlight LED strings).

At 302, display backlight voltage optimization 300 includes starting the optimization 300 (upon a display enable event, for example). In some embodiments, once the display that includes the display backlight is turned on, parameters of all the strings are obtained (for example, voltage parameters of all the strings are obtained). At 304 characterizing of each of the display backlight strings (for example, LED strings) is started. At 306, information about the display backlight strings is extracted, such as, for example, the number of strings and the voltage required for each string to maintain a constant current. A determination is made at 308 as to whether a grouping of the display backlight strings (for example, LED strings) based on, for example, a proximity of the string voltages, would yield overall power benefits. If the determination at 308 is that a grouping of the strings would yield overall power benefits (for example, if voltages of one or more strings are different or vastly different from other strings, for example, based on certain predetermined characteristic differences), at 310 a backlight output voltage (for example, a backlight boost output voltage) and a charge voltage (for example, a negative charge pump voltage) are applied to the grouped strings. For example, in some embodiments, a voltage such as a negative voltage is only applied to groups of strings that are much higher in voltage than other groups, for example. If the determination at 308 is that a grouping of the strings would not yield overall power benefits, optimization 300 goes to box 312, and the strings are not grouped. For example, at 312, an adaptive output voltage control loop is used to set the backlight voltage (for example, the backlight boost voltage). After box 310 or box 312, optimization 300 flows to box 314, which represents that string voltage and/or current levels are monitored at regular intervals, and flow returns to box 306. In some embodiments, once grouping occurs it need not be maintained in the same grouping during operation. That is, in some embodiments, display backlight strings can be dynamically grouped and regrouped as part of, for example, optimization 300.

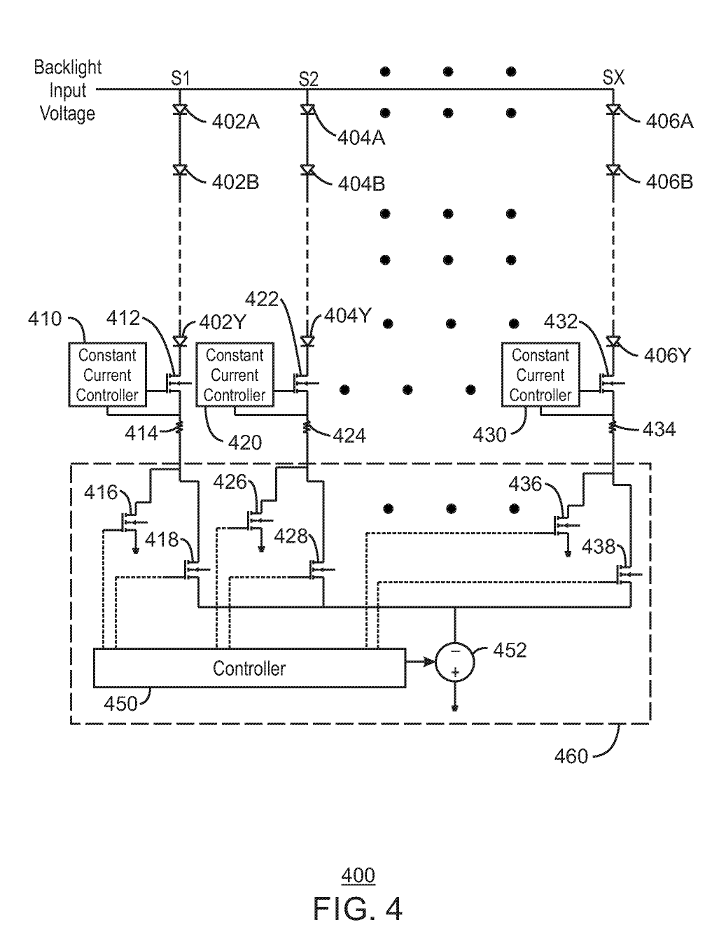

FIG. 4 illustrates display backlight circuit 400, in which a display backlight includes X strings S1, S2, . . . , SX, and each of the X strings includes Y light sources (for example each of the X strings includes Y LEDs). For example, in some embodiments, circuit 400 includes seven strings S1, S2, S3, S4, S5, S6 and S7, and each of the seven strings includes seven LEDs. In some embodiments, the number of strings can be any number X, the number of LEDs in each string can be any number Y. In some embodiments, the number X and the number Y can be the same number. In some embodiments, the number X and the number Y can be different numbers. That is, in some embodiments, any number of strings (S1, S2, . . . , SX) may be included, and in some embodiments, any number of LEDs can be included in each string. Display backlight circuit 400 includes a backlight input voltage that is provided to each of the X strings of LEDs. String S1 includes, for example, LED 402A, LED 402B, . . . , and LED 402Y. String S2 includes, for example, LED 404A, LED 404B, . . . , and LED 404Y. String SX includes, for example, LED 406A, LED 406B, . . . , and LED 406Y. In some embodiments, one or more or all of the LEDs 402A, 402B, . . . , 402Y, 404A, 404B, . . . , 404Y, . . . , 406A, 406B, . . . , 406Y can be physically located near an edge or at an edge of a display panel of a display device. In some embodiments, one or more or all of the LEDs 402A, 402B, . . . , 402Y, 404A, 404B, . . . , 404Y, . . . , 406A, 406B, . . . , 406Y can be physically located in other locations than at or near an edge of a display panel of a display device, for example. For example, in some embodiments, one or more or all of the LEDs 402A, 402B, . . . , 402Y, 404A, 404B, . . . , 404Y, . . . , 406A, 406B, . . . , 406Y can be physically located at a back of a display panel of a display device. In some embodiments such as high data rate (HDR) embodiments, for example, one or more or all of the LEDs 402A, 402B, . . . , 402Y, 404A, 404B, . . . , 404Y, . . . , 406A, 406B, . . . , 406Y can be physically located at a back of a display panel of a display device.

For each of the strings S1, S2, . . . , SX, circuit 400 can also include a respective transistor (for example, a field effect transistor or FET), a constant current controller, and a resistor. For example, a constant current controller 410, a transistor 412 (for example, a FET 412), and a resistor 414 can be coupled in series with the LEDs 402A, 402B, . . . , 402Y of string S1. Similarly, a constant current controller 420, a transistor 422 (for example, a FET 422), and a resistor 424 can be coupled in series with the LEDs 404A, 404B, . . . , 404Y of string S2, and a constant current controller 430, a transistor 432 (for example, a FET 432), and a resistor 434 can be coupled in series with the LEDs 406A, 406B, . . . , 406Y of string SX, etc.

Circuit 400 can also include additional control logic for negative biasing and grouping of strings. For example, transistors 416 and 418 (for example, FETs 416 and 418) can be coupled in parallel with each other and in series with LEDs 402A, 402B, . . . , 402Y, constant current controller 410, transistor 412 and resistor 414 of string S1. Similarly, transistors 426 and 428 (for example, FETs 426 and 428) can be coupled in parallel with each other and in series with LEDs 404A, 404B, . . . , 404Y, constant current controller 420, transistor 422 and resistor 424 of string S2, and transistors 436 and 438 (for example, FETs 436 and 438) can be coupled in parallel with each other and in series with LEDs 406A, 406B, . . . , 406Y, constant current controller 430, transistor 432 and resistor 434 of string SX, etc. It is noted that in some embodiments, as illustrated by dots in FIG. 4, other strings can be included in circuit 400 between string S2 and SX, with similar circuit elements such as LEDs, constant current controllers, transistors, resistors, etc.

In some embodiments, circuit 400 includes a controller 450 and a negative voltage source 452. In some embodiments, controller 450 implements display backlight voltage optimization (for example, controller 450 can implement display backlight voltage optimization as described and/or illustrated herein, such as in reference to FIG. 2A, FIG. 2B, and/or FIG. 3, for example). For example, in some embodiments, controller 450 can group the strings S1, S2, . . . , SX based on their characteristics (for example, as described herein, and/or based on voltage characteristics such as forward voltage characteristics). In some embodiments, controller 450 can control an amplitude of the negative voltage source 452. In some embodiments, controller 450 can control a transistor path selection based on a grouping of the strings. In some embodiments, controller 450 can be implemented using software and/or a processor implementing software. As mentioned above, in some embodiments, controller 450 can control amplitude of the negative voltage source 452. In some embodiments, controller 450 can control a transistor path selection of, for example, transistors 416, 418, 426, 428, . . . , 436, and/or 438. This transistor path selection is illustrated by the dotted lines between controller 450 and the transistors 416, 418, 426, 428, . . . , 436 and 438, for example. This transistor path selection can be chosen for example, for a first group of strings (for example, a group of lower voltage strings) to use the left transistor that is connected to ground (for example, transistors 416, 426, . . . , 438) and for a second group of strings (for example, a group of higher voltage strings) to use the right transistor that is connected to the negative voltage source 452 (for example, transistors 418, 428, . . . , 438).

In some embodiments, the dotted line 460 including transistors 416, 418, 426, 428, . . . , 436 and 438, controller 450 and negative voltage source 452 can be included in a display backlight driver, a display backlight controller, an LED driver, an LED controller, a display backlight boost controller, and/or a display backlight boost driver. In some embodiments, the dotted line 460 can additionally include constant current controllers 410, 420, . . . , 430, transistors 412, 422, . . . , 432, and/or resistors 414, 424, . . . , 434, which can be included with transistors 416, 418, 426, 428, . . . , 436 and 438, controller 450 and negative voltage source 452 in a display backlight driver, a display backlight controller, an LED driver, an LED controller, a display backlight boost controller, and/or a display backlight boost driver. In some embodiments, display backlight control implemented, for example, within dotted line 460 and/or controller 450 can implement negative biasing and grouping of strings. In some embodiments, integration of the circuit elements within dotted line 460 and/or of controller 450 does not add significant cost or complexity to a display backlight boost controller and/or display backlight boost driver. In some embodiments, the elements within dotted line 460 can include a low cost inverting charge pump, which can, for example, be implemented using lower voltage rails (for example, 1.05V or 1.8V rails) available on the computing platform. In some embodiments, this can ensure a high efficiency charge pump.

As an example, in some embodiments, for example, in which circuit 400 includes seven strings S1, S2, S3, S4, S5, S6 and S7 (for example, where X equals 7), two of the strings might be having higher voltage than the other strings and two groups may be implemented. For example, strings S1 and S7 (SX) may have higher voltage characteristics than strings S2, S3, S4, S5, and S6, so strings S1 and S7 are included in a first group of strings and strings S2, S3, S4, S5, and S6 are included in a second group of strings according to some embodiments. Therefore, in some embodiments, the negative voltage of negative voltage source 452 are applied to strings S1 and S7, but the negative voltage of negative voltage source 452 is not applied to groups S2, S3, S4, S5, and S6. The common backlight input voltage at the top of FIG. 4 is applied to the anode side of the diodes of all of the strings S1, S2, S3, S4, S5, S6, and S7. In this example, on the cathode side of the diodes, strings S1 and S7 are clocked together and the negative voltage of negative voltage source 452 is applied to the cathode side of strings S1 and S7 (for example, via transistors 418 and 438, respectively). For strings S2, S3, S4, S5, and S6, however, the alternate transistor is applied on the cathode side (for example, transistor 426 of string S2), which connects the circuit to ground rather than to the negative voltage source 452. Although strings S3, S4, S5 and S6 are not directly illustrated, similar transistors ground those strings in a manner similar to the transistor 426 of string S2. In an embodiment where it is determined that all strings can be grouped together in one group (for example, no grouping such as in box 312 of optimization 300 of FIG. 3), for example, all strings S1, S2, S3, S4, S5, S6 and S7 can be coupled to ground using the left transistor of that string 416, 426, . . . , 436, and none of the strings are coupled to an additional voltage source such as negative voltage source 452 for voltage adjustment.

It is noted that temperature variations can impact forward voltage requirements on display backlight strings. According to some embodiments, string voltages can be monitored on an ongoing basis (for example, dynamically, at regular intervals, and/or using controller 450). In some embodiments, string grouping can be dynamically changed (for example, at pulse width modulation off time) in order to optimize power. This dynamic regrouping can be implemented using controller 450, for example. String grouping and negative voltage source amplitude can be set by controller 450. For example, controller 450 can determine string grouping, boost voltage, negative source voltage setting, etc. Controller 450 can also decide not to group any of the strings (for example, due to a high number of high voltage strings). If controller 450 decides not to group any strings, then transistors 416, 426 and 436 will be turned on and transistors 418, 428 and 438 will be turned off, for example. In any case, controller 450 can control transistors 416, 418, 426, 428, . . . , 436 and/or 438 to enhance appropriate grouping implementation as described herein, for example.

Additionally, although circuit 400 includes one negative voltage source 452, it is noted that in some embodiments, circuit 400 can include more than one negative voltage source in order to enhance additional grouping and application of different voltages to different groups of strings according to some embodiments.

It is also noted that while elements such as controller 450 and/or negative voltage source 452, and/or functionality such as display backlight optimization are described and/or illustrated as being included in circuit 400 and/or within a display device, a display backlight, a display controller, etc., in some embodiments these or other elements of circuit 400 can be included in other circuitry. For example, in some embodiments, controller 450 can be included in a display backlight. In some embodiments, controller 450 can be included in a display, but not within display backlight circuitry. In some embodiments, all or a portion of the optimization, string grouping, control, etc. implemented by controller 450 can be implemented using a processor such as a central processing unit (CPU) and/or a system on a chip (SoC) of a device that includes a display or display backlight, but where the processor, SoC, or central processing unit, etc. of the device is not included in the display or display backlight. In some embodiments, for example, controller 450 and/or some of the optimization, string grouping, and/or other functionality can be included in a host device that is communicatively coupled to the display and/or display backlight (for example, via a wired or wireless coupling).

Any of the embodiments can be used to optimize display power in a display that includes backlight display panels (for example, a display that includes LED backlight display panels). According to some embodiments, saved display power can be redirected to boost system performance, to enhance battery fast charging time, and/or to improve system battery life, etc. In some embodiments, display backlight control can be implemented on computing devices such as, for example, phones, laptops, portable all in ones, display monitors, etc. In some embodiments, display backlight control can use fixed voltage and/or adaptive output voltage control to set backlight voltages (for example, to set LED backlight boost voltage).

In some embodiments, display backlight control can be implemented in which each individual display panel is operated at an optimized power level. In some embodiments, a platform or system processor such as a processor or system on chip (SoC) can determine where to redirect power saved using display backlight implementations described herein. For example, in some embodiments, if display backlight power is saved, speed step power levels or turbo levels can be increased. In some embodiments, a system or platform can use saved display backlight power to enhance a battery charging time (for example, during a powering mode when an adapter is plugged in). In some embodiments, a system or platform can use saved display backlight power to help increase system battery life (for example, during a usage mode when an adapter is not plugged in).

Some embodiments have been described herein as grouping strings of display backlight light sources (for example, LEDs) based on voltage. However, it is noted that in some embodiments factors such as light source characteristics (for example, LED characteristics) or temperature (for example, temperature of the LED panel) can effect voltage. In some embodiments, strings of display backlight sources (such as LEDs) can be grouped based on factors such as, for example, light source characteristics (for example, LED characteristics), temperature (for example, display panel temperature), etc. or other factors.

It is noted that some embodiments have been described herein as grouping strings of display backlight light sources (for example, LEDs) into two groups of strings. However, in some embodiments, the strings can be grouped into three or more groups of strings. Similarly, in some embodiments, the strings can be grouped into one group of strings (for example, if characteristics of all strings are similar and/or in a similar range). It is noted that in embodiments in which display backlight strings are grouped into three or more groups of strings, three or more different voltages may be applied to the groups. Some embodiments are not limited to only one negative voltage source 452. For example, in some embodiments of FIG. 4, for example, an additional negative voltage source can be included in addition to negative voltage source 452, and a first group of strings may have the backlight input voltage applied, a second group of strings may have the backlight input voltage adjusted by a voltage such as a negative voltage (for example, using negative voltage source 452), and a third group of strings may have the backlight input voltage adjusted by another voltage such as another negative voltage (for example, using an additional negative voltage source not illustrated in FIG. 4). Any number of groups may be included in which any number of the groups can have different voltages (or negative voltages) applied (for example, using any number of voltage sources such as negative voltage sources).

In some embodiments, negative voltage source 452 can be adjusted based on a difference between highest voltages of two different groups. For example, in reference to some embodiments illustrated in FIG. 2A and FIG. 2B, for example, the negative voltage source 452 can have an amplitude of −1 volt (the difference between the highest voltage in group 2 (24.5V from string S2) and the highest voltage in group 1 (25.5V from string S3). It is also noted that in some embodiments, voltage source 452 can be adjustable during operation. For example, if a high voltage of one or more groups changes during operation the amplitude of the negative voltage source 452 can be changed accordingly (for example, using controller 450). In some embodiments, the circuit operation of circuit 400 can be changed during operation in a manner to adjust the grouping of strings. For example, if characteristics such as voltages of one or more strings change during operation of the display backlights, controller 450 can be used to regroup the strings into different groupings with different numbers of strings per group, a different number of total groups, inclusion or exclusion of certain voltage sources, and/or changing of operational state and/or use of certain transistors, etc. Circuitry 400 can be dynamically changed during dynamic regrouping, and different circuitry can be used accordingly. For example, transistors 416, 418, 426, 428, . . . , 436, 438, etc. can be switched between states to connect some strings to ground and/or some strings to voltage sources such as negative voltage source 452 and/or other voltage sources depending on the dynamic grouping being implemented using, for example, controller 450, and the arrangement of the groups and transistors can be dynamically changed and updated during operation of the circuit 400 (for example, based on changing voltage characteristics of the strings).

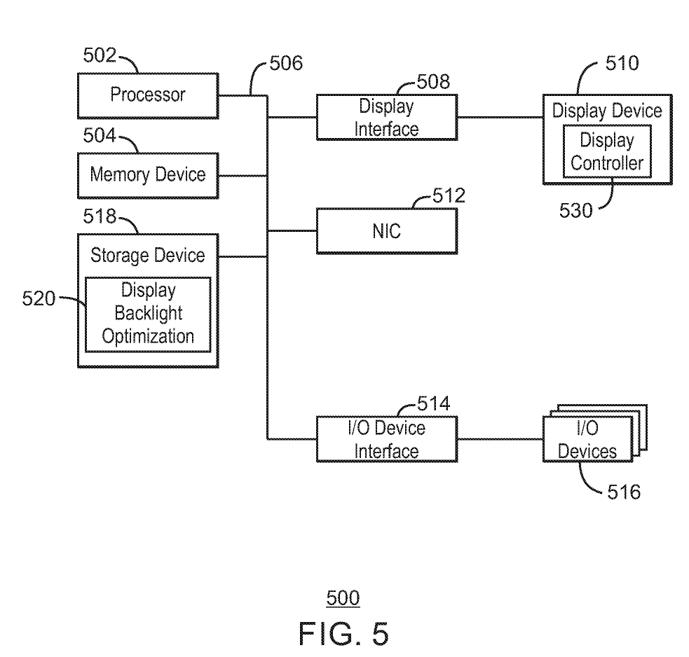

FIG. 5 is a block diagram of an example of a computing device 500. In some embodiments, computing device 500 can include display features including one or more of display backlight voltage optimization, display backlight string grouping, display power saving, display backlight control, and/or other display features discussed herein according to some embodiments. For example, any of the features illustrated in and/or described in reference to FIG. 1, FIG. 2A, FIG. 2B, FIG. 3 and/or FIG. 4 can be included within computing device 500.

The computing device 500 may be, for example, a mobile device, phone, laptop computer, notebook, tablet, all in one, 2 in 1, and/or desktop computer, etc., among others. The computing device 500 may include a processor 502 that is adapted to execute stored instructions, as well as a memory device 504 (and/or storage device 504) that stores instructions that are executable by the processor 502. The processor 502 can be a single core processor, a multi-core processor, a computing cluster, or any number of other configurations. For example, processor 502 can be an Intel® processor such as an Intel® Celeron, Pentium, Core, Core i3, Core i5, or Core i7 processor. In some embodiments, processor 502 can be an Intel® x86 based processor. In some embodiments, processor 502 can be an ARM based processor. The memory device 504 can be a memory device and/or a storage device, and can include volatile storage, non-volatile storage, random access memory, read only memory, flash memory, and/or any other suitable memory and/or storage systems. The instructions that are executed by the processor 502 may also be used to implement features described in this specification, including display coordinate configuration, for example.

The processor 502 may also be linked through a system interconnect 506 (e.g., PCI®, PCI-Express®, NuBus, etc.) to a display interface 508 adapted to connect the computing device 500 to a display device 510. In some embodiments, display device 510 can include any display screen as described or illustrated herein. For example, display device 510 can also include a backlight with backlight strings as described and/or illustrated herein. The display device 510 may include a display screen that is a built-in component of the computing device 500. The display device 510 may also include a computer monitor, television, or projector, among others, that is externally connected to the computing device 500. The display device 510 can include liquid crystal display (LCD), for example. In addition, display device 510 can include a backlight including light sources such as light emitting diodes (LEDs), organic light emitting diodes (OLEDs), and/or micro-LEDs (μLEDs), among others.

In some embodiments, the display interface 508 can include any suitable graphics processing unit, transmitter, port, physical interconnect, and the like. In some examples, the display interface 508 can implement any suitable protocol for transmitting data to the display device 510. For example, the display interface 508 can transmit data using a high-definition multimedia interface (HDMI) protocol, a DisplayPort protocol, or some other protocol or communication link, and the like

In some embodiments, display device 510 includes a display controller 530. In some embodiments, the display controller 530 can provide control signals within and/or to the display device 510. In some embodiments, all or portions of the display controller 530 can be included in the display interface 508 (and/or instead of or in addition to being included in the display device 510). In some embodiments, all or portions of the display controller 530 can be coupled between the display interface 508 and the display device 510. In some embodiments, all or portions of the display controller 530 can be coupled between the display interface 508 and the interconnect 506. In some embodiments, all or portions of the display controller 530 can be included in the processor 502. In some embodiments, display controller 530 can implement display backlight voltage optimization, display backlight string grouping, display power saving, display backlight control, and/or other display features according to any of the examples illustrated in any of the drawings and/or as described anywhere herein. For example, any of the features illustrated in and/or described in reference to FIG. 1, FIG. 2A, FIG. 2B, FIG. 3 and/or FIG. 4 can be included within display controller 530.

In some embodiments, any of the techniques described in this specification can be implemented entirely or partially within the display device 510. In some embodiments, any of the techniques described in this specification can be implemented entirely or partially within the display controller 530. In some embodiments, any of the techniques described in this specification can be implemented entirely or partially within the processor 502.

In addition, a network interface controller (also referred to herein as a NIC) 512 may be adapted to connect the computing device 500 through the system interconnect 506 to a network (not depicted). The network (not depicted) may be a wireless network, a wired network, cellular network, a radio network, a wide area network (WAN), a local area network (LAN), a global position satellite (GPS) network, and/or the Internet, among others.

The processor 502 may be connected through system interconnect 506 to an input/output (I/O) device interface 514 adapted to connect the computing host device 500 to one or more I/O devices 516. The I/O devices 516 may include, for example, a keyboard and/or a pointing device, where the pointing device may include a touchpad or a touchscreen, among others. The I/O devices 516 may be built-in components of the computing device 500, or may be devices that are externally connected to the computing device 500.

In some embodiments, the processor 502 may also be linked through the system interconnect 506 to a storage device 518 that can include a hard drive, a solid state drive (SSD), a magnetic drive, an optical drive, a portable drive, a flash drive, a Universal Serial Bus (USB) flash drive, an array of drives, and/or any other type of storage, including combinations thereof. In some embodiments, the storage device 518 can include any suitable applications. In some embodiments, the storage device 518 can include a basic input/output system (BIOS).

In some embodiments, the storage device 518 can include any device or software, instructions, etc. that can be used (for example, by a processor such as processor 502) to implement any of the functionality described herein such as display coordinate configuration. In some embodiments, for example, display backlight optimization 520 is included in storage device 518. In some embodiments, display backlight optimization 520 can be used to provide optimization as described herein (for example, optimization 520 can include display backlight voltage optimization, display backlight string grouping, display power saving, display backlight control, and/or other display features according to any of the examples illustrated in any of the drawings and/or as described anywhere herein). For example, any of the features illustrated in and/or described in reference to FIG. 1, FIG. 2A, FIG. 2B, FIG. 3 and/or FIG. 4 can be included within optimization 520.

It is to be understood that the block diagram of FIG. 5 is not intended to indicate that the computing device 500 is to include all of the components shown in FIG. 5. Rather, the computing device 500 can include fewer and/or additional components not illustrated in FIG. 5 (e.g., additional memory components, embedded controllers, additional modules, additional network interfaces, etc.). Furthermore, any of the functionalities of the BIOS or of the optimization 520 that can be included in storage device 518 may be partially, or entirely, implemented in hardware and/or in the processor 502. For example, the functionality may be implemented with an application specific integrated circuit, logic implemented in an embedded controller, or in logic implemented in the processor 502, among others. In some embodiments, the functionalities of the BIOS and/or optimization 520 can be implemented with logic, wherein the logic, as referred to herein, can include any suitable hardware (e.g., a processor, among others), software (e.g., an application, among others), firmware, or any suitable combination of hardware, software, and firmware.

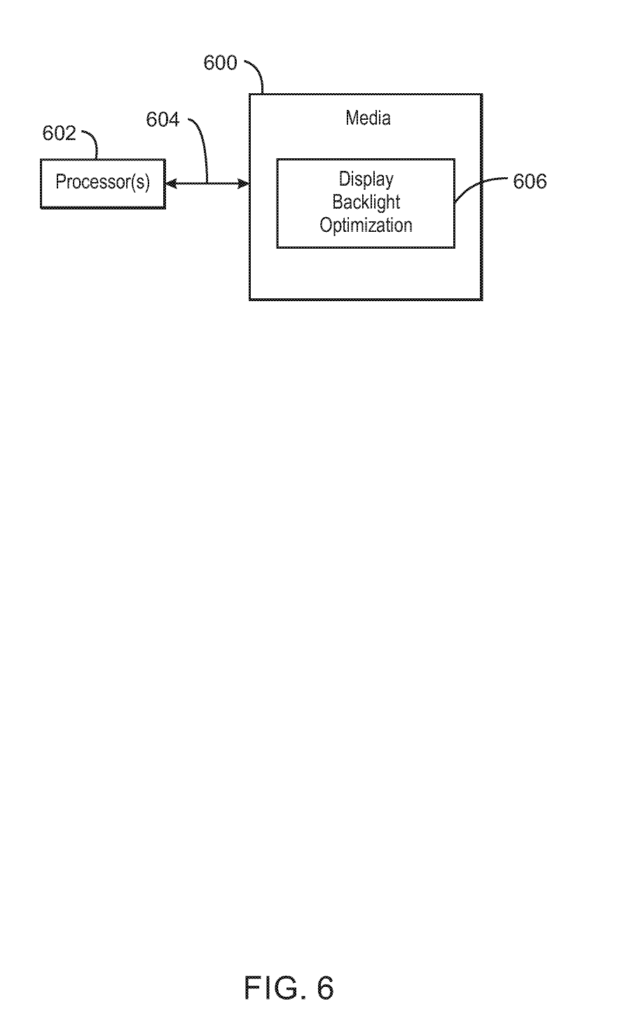

FIG. 6 is a block diagram of an example of one or more processor and one or more tangible, non-transitory computer readable media. The one or more tangible, non-transitory, computer-readable media 600 may be accessed by a processor or processors 602 over a computer interconnect 604. Furthermore, the one or more tangible, non-transitory, computer-readable media 600 may include code to direct the processor 602 to perform operations as described herein. For example, in some embodiments, computer-readable media 600 may include code to direct the processor to perform automatic display backlight optimization 606 according to some embodiments. In some embodiments, display backlight optimization 606 can be used to provide optimization as described herein (for example, optimization 606 can include display backlight voltage optimization, display backlight string grouping, display power saving, display backlight control, and/or other display features according to any of the examples illustrated in any of the drawings and/or as described anywhere herein). For example, any of the features illustrated in and/or described in reference to FIG. 1, FIG. 2A, FIG. 2B, FIG. 3 and/or FIG. 4 can be included within optimization 606.

In some embodiments, processor 602 is one or more processors. In some embodiments, processor 602 can perform similarly to (and/or the same as) processor 502 of FIG. 5, and/or can perform some or all of the same functions as can be performed by processor 502.

Various components discussed in this specification may be implemented using software components. These software components may be stored on the one or more tangible, non-transitory, computer-readable media 600, as indicated in FIG. 6. For example, software components including, for example, computer readable instructions implementing automatic display backlight optimization 606 may be included in one or more computer readable media 600 according to some embodiments. Display coordinate configuration 806 may be adapted to direct the processor 602 to perform one or more of any of the operations described in this specification and/or in reference to the drawings.

It is to be understood that any suitable number of software components may be included within the one or more tangible, non-transitory computer-readable media 600. Furthermore, any number of additional software components not shown in FIG. 6 may be included within the one or more tangible, non-transitory, computer-readable media 600, depending on the specific application.

Reference in the specification to “one embodiment” or “an embodiment” or “some embodiments” of the disclosed subject matter means that a particular feature, structure, or characteristic described in connection with the embodiment is included in at least one embodiment of the disclosed subject matter. Thus, the phrase “in one embodiment” or “in some embodiments” may appear in various places throughout the specification, but the phrase may not necessarily refer to the same embodiment or embodiments.

### Example 1

In some examples, display backlight strings are grouped into at least two groups based on voltage characteristics of the display backlight strings. A first of the at least two groups of display backlight strings is operated at a first operating voltage. A second of the at least two groups of display backlight strings is operated at a second operating voltage.

### Example 2

In some examples, a method includes grouping display backlight strings into at least two groups based on voltage characteristics of the display backlight strings, operating a first of the at least two groups of display backlight strings at a first operating voltage, and operating a second of the at least two groups of display backlight strings at a second operating voltage.

### Example 3

In some examples, an apparatus includes a voltage source and a controller. The controller is to group display backlight strings into at least two groups based on voltage characteristics of the display backlight strings, operate a first of the at least two groups of display backlight strings at a first operating voltage, and operate a second of the at least two groups of display backlight strings at a second operating voltage by adjusting an input voltage using the voltage source.

### Example 4

In some examples, one or more tangible, non-transitory machine readable media include a plurality of instructions that, in response to being executed on at least one processor, cause the at least one processor to group display backlight strings into at least two groups based on voltage characteristics of the display backlight strings, to operate a first of the at least two groups of display backlight strings at a first operating voltage, and to operate a second of the at least two groups of display backlight strings at a second operating voltage.

### Example 5

In some examples, a method including grouping display backlight strings into at least two groups based on one or more characteristics of the display backlight strings, operating a first of the at least two groups of display backlight strings at a first operating voltage, and/or operating a second of the at least two groups of display backlight strings at a second operating voltage.

### Example 6

In some examples, the method of any Example, including grouping the display backlight strings into the at least two groups based on one or more voltage characteristics of the display backlight strings.

### Example 7

In some examples, the method of any Example, including grouping the display backlight strings into the at least two groups based on one or more forward voltage characteristics of the display backlight strings.

### Example 8

In some examples, the method of any Example, including setting the first operating voltage and the second operating voltage based on a highest string voltage characteristic of one or more of the at least two groups.

### Example 9

In some examples, the method of any Example, including setting the first operating voltage and the second operating voltage based on a highest string voltage of a plurality of the at least two groups.

### Example 10

In some examples, the method of any Example, including applying an adjusted voltage to the strings in at least one of the groups.

### Example 11

In some examples, the method of any Example, including applying a negative adjusted voltage to the strings in at least one of the groups.

### Example 12

In some examples, the method of any Example, where each of the display backlight strings includes a plurality of light sources.

### Example 13

In some examples, the method of any Example, where each of the display backlight strings includes a plurality of light emitting diodes.

### Example 14

In some examples, the method of any Example, including operating a third of the at least two groups of display backlight strings at a third operating voltage.

### Example 15

In some examples, the method of any Example, including dynamically re-grouping the display backlight strings into at least two new groups based on one or more updated characteristics of the display backlight strings, operating a first of the at least two new groups of display backlight strings at an operating voltage, and/or operating a second of the at least two new groups of display backlight strings at an operating voltage that is different than the first of the at least two new groups.

### Example 16

In some examples, an apparatus including a voltage source and a controller. The controller is to group display backlight strings into at least two groups based on one or more characteristics of the display backlight strings, to operate a first of the at least two groups of display backlight strings at a first operating voltage, and/or to operate a second of the at least two groups of display backlight strings at a second operating voltage by adjusting an input voltage using the voltage source.

### Example 17

In some examples, the apparatus of any Example, the controller to group the display backlight strings into the at least two groups based on one or more voltage characteristics of the display backlight strings.

### Example 18

In some examples, the apparatus of any Example, the controller to group the display backlight strings into the at least two groups based on one or more forward voltage characteristics of the display backlight strings.

### Example 19

In some examples, the apparatus of any Example, the controller to set the first operating voltage and the second operating voltage based on a highest string voltage characteristic of one or more of the at least two groups.

### Example 20

In some examples, the apparatus of any Example, the controller to set the first operating voltage and the second operating voltage based on a highest string voltage of a plurality of the at least two groups.

### Example 21

In some examples, the apparatus of any Example, the controller and/or the voltage source to apply an adjusted voltage to the strings in at least one of the groups.

### Example 22

In some examples, the apparatus of any Example, wherein the voltage source is a negative voltage source. The controller and/or the negative voltage source are to apply a negative adjusted voltage to the strings in at least one of the groups.

### Example 23

In some examples, the apparatus of any Example, where each of the display backlight strings includes a plurality of light sources.

### Example 24

In some examples, the apparatus of any Example, where each of the display backlight strings includes a plurality of light emitting diodes.

### Example 25

In some examples, the apparatus of any Example, including a second voltage source. The controller and/or the second voltage source are to operate a third of the at least two groups of display backlight strings at a third operating voltage.

### Example 26

In some examples, the apparatus of any Example, the controller to dynamically re-group the display backlight strings into at least two new groups based on one or more updated characteristics of the display backlight strings, to operate a first of the at least two new groups of display backlight strings at an operating voltage, and/or to control the voltage source to operate a second of the at least two new groups of display backlight strings at an operating voltage that is different than the first of the at least two new groups.

### Example 27

In some examples, one or more tangible, non-transitory machine readable media including a plurality of instructions that, in response to being executed on at least one processor, cause the at least one processor to group display backlight strings into at least two groups based on voltage characteristics of the display backlight strings, to operate a first of the at least two groups of display backlight strings at a first operating voltage, and/or to operate a second of the at least two groups of display backlight strings at a second operating voltage.

### Example 28

In some examples, the one or more tangible, non-transitory machine readable media of any Example, including a plurality of instructions that, in response to being executed on at least one processor, cause the at least one processor to group the display backlight strings into the at least two groups based on one or more voltage characteristics of the display backlight strings.

### Example 29

In some examples, the one or more tangible, non-transitory machine readable media of any Example, including a plurality of instructions that, in response to being executed on at least one processor, cause the at least one processor to group the display backlight strings into the at least two groups based on one or more forward voltage characteristics of the display backlight strings.

### Example 30

In some examples, the one or more tangible, non-transitory machine readable media of any Example, including a plurality of instructions that, in response to being executed on at least one processor, cause the at least one processor to set the first operating voltage and the second operating voltage based on a highest string voltage characteristic of one or more of the at least two groups.

### Example 31

In some examples, the one or more tangible, non-transitory machine readable media of any Example, including a plurality of instructions that, in response to being executed on at least one processor, cause the at least one processor to set the first operating voltage and the second operating voltage based on a highest string voltage of a plurality of the at least two groups.

### Example 32

In some examples, the one or more tangible, non-transitory machine readable media of any Example, including a plurality of instructions that, in response to being executed on at least one processor, cause the at least one processor to apply an adjusted voltage to the strings in at least one of the groups.

### Example 33

In some examples, the one or more tangible, non-transitory machine readable media of any Example, including a plurality of instructions that, in response to being executed on at least one processor, cause the at least one processor to apply a negative adjusted voltage to the strings in at least one of the groups.

### Example 34

In some examples, the one or more tangible, non-transitory machine readable media of any Example, where each of the display backlight strings includes a plurality of light sources.

### Example 35

In some examples, the one or more tangible, non-transitory machine readable media of any Example, where each of the display backlight strings includes a plurality of light emitting diodes.

### Example 36

In some examples, the one or more tangible, non-transitory machine readable media of any Example, including a plurality of instructions that, in response to being executed on at least one processor, cause the at least one processor to operate a third of the at least two groups of display backlight strings at a third operating voltage.

### Example 37

In some examples, the one or more tangible, non-transitory machine readable media of any Example, including a plurality of instructions that, in response to being executed on at least one processor, cause the at least one processor to dynamically re-group the display backlight strings into at least two new groups based on one or more updated characteristics of the display backlight strings, to operate a first of the at least two new groups of display backlight strings at an operating voltage, and/or to operate a second of the at least two new groups of display backlight strings at an operating voltage that is different than the first of the at least two new groups.

### Example 38

In some examples, an apparatus includes a voltage source, means for grouping display backlight strings into at least two groups based on one or more characteristics of the display backlight strings, means for operating a first of the at least two groups of display backlight strings at a first operating voltage, and/or means for operating a second of the at least two groups of display backlight strings at a second operating voltage by adjusting an input voltage using the voltage source.

### Example 39

In some examples, the apparatus of any Example, including means for grouping the display backlight strings into the at least two groups based on one or more voltage characteristics of the display backlight strings.

### Example 40

In some examples, the apparatus of any Example, including means for grouping the display backlight strings into the at least two groups based on one or more forward voltage characteristics of the display backlight strings.

### Example 41

In some examples, the apparatus of any Example, including means for setting the first operating voltage and the second operating voltage based on a highest string voltage characteristic of one or more of the at least two groups.

### Example 42

In some examples, the apparatus of any Example, including means for setting the first operating voltage and the second operating voltage based on a highest string voltage of a plurality of the at least two groups.

### Example 43

In some examples, the apparatus of any Example, including means for applying an adjusted voltage to the strings in at least one of the groups.

### Example 44

In some examples, the apparatus of any Example, where the voltage source is a negative voltage source, and including means for applying the negative voltage source to apply a negative adjusted voltage to the strings in at least one of the groups.

### Example 45

In some examples, the apparatus of any Example, where each of the display backlight strings includes a plurality of light sources.

### Example 46

In some examples, the apparatus of any Example, where each of the display backlight strings includes a plurality of light emitting diodes.

### Example 47

In some examples, the apparatus of any Example, including means for operating a third of the at least two groups of display backlight strings at a third operating voltage.

### Example 48

In some examples, the apparatus of any Example, including means for dynamically re-grouping the display backlight strings into at least two new groups based on one or more updated characteristics of the display backlight strings, means for operating a first of the at least two new groups of display backlight strings at an operating voltage, and/or means for controlling the voltage source to operate a second of the at least two new groups of display backlight strings at an operating voltage that is different than the first of the at least two new groups.

### Example 49

In some examples, a machine-readable medium including code, when executed, to cause a machine to perform the method or apparatus of any Example.

### Example 50

In some examples, an apparatus including means to perform a method as in any Example.

### Example 51

In some examples, machine-readable storage including machine-readable instructions, when executed, to implement a method or realize an apparatus as in any Example.

Although example embodiments of the disclosed subject matter are described with reference to circuit diagrams, flow diagrams, block diagrams etc. in the drawings, persons of ordinary skill in the art will readily appreciate that many other ways of implementing the disclosed subject matter may alternatively be used. For example, the arrangements of the elements in the diagrams, and/or the order of execution of the blocks in the diagrams may be changed, and/or some of the circuit elements in circuit diagrams, and blocks in block/flow diagrams described may be changed, eliminated, or combined. Any elements as illustrated and/or described may be changed, eliminated, or combined.

In the preceding description, various aspects of the disclosed subject matter have been described. For purposes of explanation, specific numbers, systems and configurations were set forth in order to provide a thorough understanding of the subject matter. However, it is apparent to one skilled in the art having the benefit of this disclosure that the subject matter may be practiced without the specific details. In other instances, well-known features, components, or modules were omitted, simplified, combined, or split in order not to obscure the disclosed subject matter.

Various embodiments of the disclosed subject matter may be implemented in hardware, firmware, software, or combination thereof, and may be described by reference to or in conjunction with program code, such as instructions, functions, procedures, data structures, logic, application programs, design representations or formats for simulation, emulation, and fabrication of a design, which when accessed by a machine results in the machine performing tasks, defining abstract data types or low-level hardware contexts, or producing a result.

Program code may represent hardware using a hardware description language or another functional description language which essentially provides a model of how designed hardware is expected to perform. Program code may be assembly or machine language or hardware-definition languages, or data that may be compiled and/or interpreted. Furthermore, it is common in the art to speak of software, in one form or another as taking an action or causing a result. Such expressions are merely a shorthand way of stating execution of program code by a processing system which causes a processor to perform an action or produce a result.

Program code may be stored in, for example, one or more volatile and/or non-volatile memory devices, such as storage devices and/or an associated machine readable or machine accessible medium including solid-state memory, hard-drives, floppy-disks, optical storage, tapes, flash memory, memory sticks, digital video disks, digital versatile discs (DVDs), etc., as well as more exotic mediums such as machine-accessible biological state preserving storage. A machine-readable medium may include any tangible mechanism for storing, transmitting, or receiving information in a form readable by a machine, such as antennas, optical fibers, communication interfaces, etc. Program code may be transmitted in the form of packets, serial data, parallel data, etc., and may be used in a compressed or encrypted format.

Program code may be implemented in programs executing on programmable machines such as mobile or stationary computers, personal digital assistants, set top boxes, cellular telephones and pagers, and other electronic devices, each including a processor, volatile and/or non-volatile memory readable by the processor, at least one input device and/or one or more output devices. Program code may be applied to the data entered using the input device to perform the described embodiments and to generate output information. The output information may be applied to one or more output devices. One of ordinary skill in the art may appreciate that embodiments of the disclosed subject matter can be practiced with various computer system configurations, including multiprocessor or multiple-core processor systems, minicomputers, mainframe computers, as well as pervasive or miniature computers or processors that may be embedded into virtually any device. Embodiments of the disclosed subject matter can also be practiced in distributed computing environments where tasks may be performed by remote processing devices that are linked through a communications network.

Although operations may be described as a sequential process, some of the operations may in fact be performed in parallel, concurrently, and/or in a distributed environment, and with program code stored locally and/or remotely for access by single or multi-processor machines. In addition, in some embodiments the order of operations may be rearranged without departing from the spirit of the disclosed subject matter. Program code may be used by or in conjunction with embedded controllers.

While the disclosed subject matter has been described with reference to illustrative embodiments, this description is not intended to be construed in a limiting sense. Various modifications of the illustrative embodiments, as well as other embodiments of the subject matter, which are apparent to persons skilled in the art to which the disclosed subject matter pertains are deemed to lie within the scope of the disclosed subject matter. For example, in each illustrated embodiment and each described embodiment, it is to be understood that the diagrams of the figures and the description herein is not intended to indicate that the illustrated or described devices include all of the components shown in a particular figure or described in reference to a particular figure. In addition, each element may be implemented with logic, wherein the logic, as referred to herein, can include any suitable hardware (e.g., a processor, among others), software (e.g., an application, among others), firmware, or any suitable combination of hardware, software, and firmware, for example.

What is claimed is:

1. A method comprising:
grouping display backlight strings into at least two groups based on one or more characteristics of the display backlight strings;
operating a first of the at least two groups of display backlight strings at a first operating voltage; and
operating a second of the at least two groups of display backlight strings at a second operating voltage.

2. The method of claim 1, comprising grouping the display backlight strings into the at least two groups based on one or more voltage characteristics of the display backlight strings.

3. The method of claim 2, comprising grouping the display backlight strings into the at least two groups based on one or more forward voltage characteristics of the display backlight strings.

4. The method of claim 2, comprising setting the first operating voltage and the second operating voltage based on a highest string voltage characteristic of one or more of the at least two groups.

5. The method of claim 2, comprising setting the first operating voltage and the second operating voltage based on a highest string voltage of a plurality of the at least two groups.

6. The method of claim 2, comprising applying an adjusted voltage to the strings in at least one of the groups.

7. The method of claim 2, comprising applying a negative adjusted voltage to the strings in at least one of the groups.

8. The method of claim 1, wherein each of the display backlight strings includes a plurality of light sources.

9. The method of claim 1, wherein each of the display backlight strings includes a plurality of light emitting diodes.

10. The method of claim 1, comprising operating a third of the at least two groups of display backlight strings at a third operating voltage.

11. The method of claim 1, comprising
dynamically re-grouping the display backlight strings into at least two new groups based on one or more updated characteristics of the display backlight strings;
operating a first of the at least two new groups of display backlight strings at an operating voltage; and
operating a second of the at least two new groups of display backlight strings at an operating voltage that is different than the first of the at least two new groups.

12. An apparatus comprising:
a voltage source; and
a controller to:
group display backlight strings into at least two groups based on one or more characteristics of the display backlight strings;
operate a first of the at least two groups of display backlight strings at a first operating voltage; and
operate a second of the at least two groups of display backlight strings at a second operating voltage by adjusting an input voltage using the voltage source.

13. The apparatus of claim 12, the controller to group the display backlight strings into the at least two groups based on one or more voltage characteristics of the display backlight strings.

14. The apparatus of claim 13, the controller to group the display backlight strings into the at least two groups based on one or more forward voltage characteristics of the display backlight strings.

15. The apparatus of claim 13, the controller to set the first operating voltage and the second operating voltage based on a highest string voltage characteristic of one or more of the at least two groups.

16. The apparatus of claim 13, the controller to set the first operating voltage and the second operating voltage based on a highest string voltage of a plurality of the at least two groups.

17. The apparatus of claim 13, the controller and/or the voltage source to apply an adjusted voltage to the strings in at least one of the groups.

18. The apparatus of claim 13, wherein the voltage source is a negative voltage source, the controller and/or the negative voltage source to apply a negative adjusted voltage to the strings in at least one of the groups.

19. The apparatus of claim 12, wherein each of the display backlight strings includes a plurality of light sources.

20. The apparatus of claim 12, wherein each of the display backlight strings includes a plurality of light emitting diodes.

21. The apparatus of claim 12, comprising a second voltage source, the controller and/or the second voltage source to operate a third of the at least two groups of display backlight strings at a third operating voltage.

22. The apparatus of claim 12, the controller to:
dynamically re-group the display backlight strings into at least two new groups based on one or more updated characteristics of the display backlight strings;
operate a first of the at least two new groups of display backlight strings at an operating voltage; and
control the voltage source to operate a second of the at least two new groups of display backlight strings at an operating voltage that is different than the first of the at least two new groups.

23. One or more tangible, non-transitory machine readable media comprising a plurality of instructions that, in response to being executed on at least one processor, cause the at least one processor to:
group display backlight strings into at least two groups based on voltage characteristics of the display backlight strings;
operate a first of the at least two groups of display backlight strings at a first operating voltage; and
operate a second of the at least two groups of display backlight strings at a second operating voltage.

24. The one or more tangible, non-transitory machine readable media of claim 23, comprising a plurality of instructions that, in response to being executed on at least one processor, cause the at least one processor to operate a third of the at least two groups of display backlight strings at a third operating voltage.

25. The one or more tangible, non-transitory machine readable media of claim 23, comprising a plurality of instructions that, in response to being executed on at least one processor, cause the at least one processor to:
dynamically re-group the display backlight strings into at least two new groups based on one or more updated characteristics of the display backlight strings;
operate a first of the at least two new groups of display backlight strings at an operating voltage; and
operate a second of the at least two new groups of display backlight strings at an operating voltage that is different than the first of the at least two new groups.
